(19) United States
(12) Patent Application Publication
(10) Pub. No.: US 2011/0246577 A1
(43) Pub. Date: Oct. 6, 2011

(54) System, Method and Apparatus for Enhanced Processing of Communication in a Peer-to-Peer Network

(76) Inventor: Michael R. Self, Fort Lauderdale, FL (US)

(21) Appl. No.: 13/159,512

(22) Filed: Jun. 14, 2011

Related U.S. Application Data
(60) Provisional application No. 61/357,627, filed on Jun. 23, 2010.

(51) Int. Cl. G06F 15/16

(52) U.S. Cl. 709/204

(57) ABSTRACT

A system, method and apparatus for enhanced processing of communications over a peer-to-peer network is provided. More particularly, rules for the processing of calls addressed to a user over a P2P network are stored in a database. Communication requests addressed to the user are forwarded by the recipient user's computer to a remote location remote for processing in accordance with the stored rules.

### CROSS-REFERENCE TO RELATED APPLICATIONS

The present application claims priority to co-pending Provisional Patent Application No. 61/357,627, filed on Jun. 23, 2010, entitled “System, Method and Apparatus for Enhanced Processing of Communications in a Peer-to-Peer Network”; that application being incorporated herein, by reference, in its entirety.

### BACKGROUND OF THE INVENTION

1. Field of the Invention

The invention relates to the field communications, and more particularly, to a system and method for enhanced processing of communications made over a peer-to-peer network.

2. Description of the Related Art

Various systems exist that facilitate the transmission of voice, video and data communications over computer networks, such as the Internet or other circuit switched, cell switched or packet-switched networks. SKYPE limited is one provider of software that uses a proprietary protocol (“the SKYPE protocol”) to communicate voice and/or video telephone calls over the Internet. In order to transfer packetized voice and/or video telephone calls, the SKYPE protocol uses a peer-to-peer (“P2P”) architecture.

In particular, the SKYPE user directory is decentralized and distributed among the nodes forming the network. Under the SKYPE protocol, each “ordinary” node maintains a host cache with the IP address and port numbers or reachable “super” nodes. Each supernode hosts a portion of the directory of users logged-in to SKYPE at that particular time. Any node of the network can be selected as a supernode based, in part, on bandwidth, firewall status and processing power. Registered users login to the SKYPE network using a unique SKYPE name (“SKYPE ID”) that is assigned an IP address. When a first registered member wishes to contact a second registered member, the first registered member types in the second members unique SKYPE ID and a lookup is used to find the second registered member IP address in the directory distributed over the supernodes. If the second registered member is logged-in to the system, the two members are connected and the second registered member can accept or decline the call. Currently, if the second registered member is not logged-in, or is not at the computer when the call comes in, or if the second registered member declines the call, the call will terminate without the first member being able to speak with the second member. The second registered member is merely alerted to a missed call by an indicator on the screen.

What is needed is a voice over IP system that utilizes a modified P2P network, wherein a user can predefine rules for receiving communications over the P2P network. What is additionally needed is a coordinated system for processing calls made to a user or from a user in a P2P network and for implementing rules of communication over the P2P network, as defined by the user.

### SUMMARY OF THE INVENTION

In order to overcome the above-mentioned disadvantages of the heretofore-known devices of this general type, it is accordingly an object of the invention to provide a system, method and apparatus for providing enhanced processing of communications over a peer-to-peer network. In one particular embodiment of the invention, a client running on a user's computer determines whether an incoming computer call should be further processed before being provided to the user. If it is determined that further processing is warranted, the call is provided to another destination for processing in accordance with rules preset by the user.

Although the invention is illustrated and described herein as embodied in a system, method and apparatus for providing enhanced processing of communications over a peer-to-peer network, it is nevertheless not intended to be limited to the details shown, since various modifications and structural changes may be made therein without departing from the spirit of the invention and within the scope and range of equivalents of the claims.

The construction of the invention, however, together with the additional objects and advantages thereof will be best understood from the following description of the specific embodiments when read in connection with the accompanying drawings.

### BRIEF DESCRIPTION OF THE SEVERAL VIEWS OF THE DRAWING

FIG. 1 is a simplified schematic diagram of a system in accordance with one particular embodiment of the present invention;

FIG. 2 is a flow diagram showing a method for initializing a user's system in accordance with one particular embodiment of the invention;

FIG. 3 is a flow diagram showing a method for processing a computer telephone call in accordance with one particular embodiment of the invention; and

FIG. 4 is a simplified illustration of an exemplary screen shot showing a screening feature in accordance with one particular embodiment of the instant invention.

FIG. 5 is a simplified illustration of an exemplary screen shot showing an attendant console feature in accordance with one particular embodiment of the instant invention.

### DESCRIPTION OF THE PREFERRED EMBODIMENTS

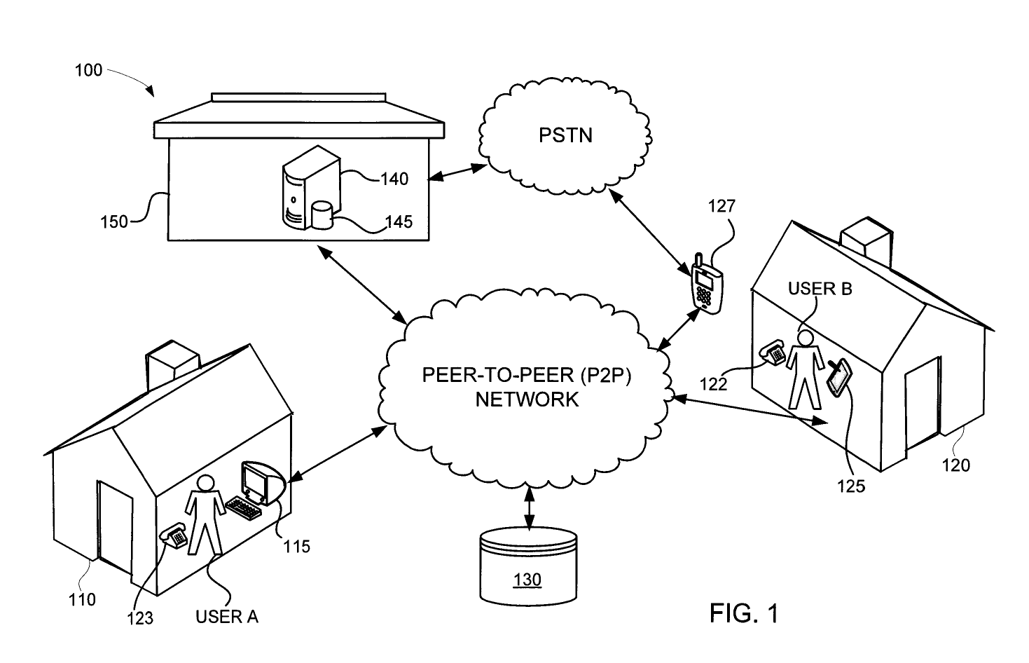

Referring now to FIG. 1, there is shown one particular embodiment of a system 100 in accordance with the present invention. The system 100 includes a peer-to-peer (P2P) network used to route communications, such as voice telephonic calls, video conferencing and instant messages, between two or more users. In one particularly preferred embodiment of the invention, the P2P network of FIG. 1 is implemented over the Internet, by certain users running software using a P2P network architecture. One example of such software is the SKYPE software application provided by SKYPE Limited. For purposes of illustration, the present invention will be described in connection with the SKYPE software application, however, the invention is not intended to be limited only to use with the SKYPE software application, as the system and methods described herein can be adapted to other P2P network architectures and systems without departing from the scope of the present invention.

Referring back to FIG. 1, two users, USER A and USER B, are connected to the Internet, or another communications network by their respective devices 115, 125, and/or other computer related devices, such as the VOIP phone or Smartphone 127. The devices 115, 125 may be embodied in any type of computing devices, including: personal computer systems having memory devices (including non-transitory memory devices) storing information, such as program code; processors/processing devices for processing information and executing programming or program code; and input and output peripherals including a display device. In one particular embodiment of the invention, the devices 115, 125 are chosen from among a group of personal computing products including, but not limited to: personal computers; “slate” or “tablet” computer (for example, Apple Computer's iPad tablet device); a mobile internet device; a “smartphone” device; and/or any other device having a Central Processing Unit, random access memory, network communications capability, user input/output interfaces and/or a capability to play and/or record audio and/or video. Each of the computing devices 115, 125, when running the SKYPE software, becomes an ad hoc node of the P2P network formed of registered SKYPE users who are currently connected to a common network and are running the SKYPE software application. The system 100 maintains a directory 130 of network addresses (usually internet IP addresses) correlated to currently signed-in users that is referenced whenever one registered user requests to communicate with another registered user. In the SKYPE system, the directory 130 is distributed over the P2P network, with a plurality of “supernodes” each holding a portion of the entire directory 130. However, if desired, the directory 130 could be stored at a central location instead of being distributed throughout the P2P network.

Currently, SKYPE limited offers, for a fee, a call-forwarding option, wherein if you are not logged into the SKYPE network, or if you are logged into the SKYPE network, but do not answer a call request within a user specified amount of time, the SKYPE system will forward the incoming call. Under the SKYPE protocol, the call is first forwarded to a user-specified telephone number and, then, optionally, if the call is unanswered, to SKYPE voicemail. However, the foregoing features described in connection with the current SKYPE system start by presenting the call to a logged-in subscriber, and then forwarding the call if the logged-in subscriber does not answer it. In accordance with the instant invention, an incoming computer call can be sent for further processing and/or forwarding before it is ever provided to the user, even if the user is currently logged in to the SKYPE network.

In one particular embodiment, the instant invention includes a software client or application that runs in combination with the SKYPE software application on a user's computer. For example, the USER A at location 110 has loaded, and is running, the SKYPE software application on his computing device 115. Similarly, the USER B at location 120 is running the SKYPE software application on her device 125. Both of the devices 115 and 125 are now operating as ad hoc nodes of the P2P network and have the ability to call each other over that network. However, USER B is additionally running a software application, in accordance with the instant invention, that intercepts a call request from the P2P network and, if indicated by a determination of the software, provides the call request to a communications processor 140 at a remote location 150 (i.e., not the location of USER A or USER B) for further processing prior to providing the call information to USER B. Such further processing includes processing the incoming communications (COMM) request in accordance with a variety of rules or instructions that USER B has predefined, using the device 125, and which are stored in a database 145 of the communications processor 140. Under such rules, a communication request can be processed, for example, to be provided to a landline phone 122 of USER B, via the public switched telephone network (PSTN), or to a VOIP or mobile phone 127, as specified by the rules set in advance by USER B, all before the USER B is ever informed of the communication request having been received by the device 125. The communications processor 140 of the remote location 150 can be, but need not be, part of the P2P network on which the call originated or of any P2P network.

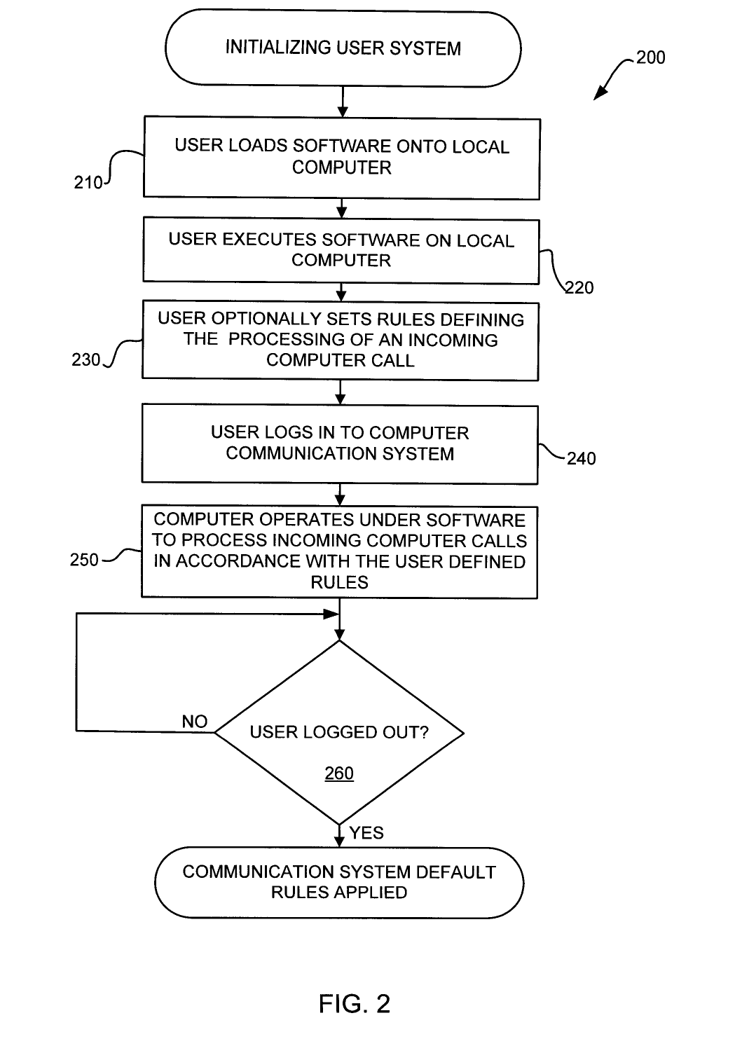

Referring more particularly to FIGS. 1 and 2, there will be described a method 200 for setting the processing of calls to a particular registered user of a P2P communications network, such as the SKYPE network. First, a user USER B loads the P2P network software application (SKYPE, for example) into a memory of the user's device 125. Step 210. The software application can contain a module for receiving and/or intercepting an incoming communication request, or such a module can be provided as an add-on program or application that runs in the background of the user's device 125, simultaneously with the main software application. The user USER B operates the software by executing the software application and module on the local device 125, wherein the computer is configured to perform the program steps of the software application and module. Step 220. Note that, as with any other computer software, step 210 need only be performed once. Upon subsequent boots, the user goes directly to step 220.

When executing the module on the device 125, the user USER B can utilize a user interface of the device 125 to define rules for handling incoming communication requests. Step 230. Note that device 125 is not the only method by which USER B may define the rules for handling incoming communications requests. USER B may utilize any device equivalent in function to device 125 that has a connection to the communications processor 140 and/or the database 145. For example, USER B can set up rules so that incoming communication requests are first provided to the telephone 122, via the PSTN, and, then, upon non-answer of the telephone 122, to a mobile device 127, to voicemail, and/or to other devices, as desired by the user, all before the communication request is ever displayed on the user's computer display, or even, instead of ever displaying the communication request on the user's computer display. As such, once the user, USER B, logs onto the P2P communications network (step 240), the module runs in the background of the user's device 125 to receive or intercept the communication requests and forward them for processing in accordance with the user's predefined rules. Step 250. If desired, the user can inform the software module to pass calls through to be displayed on a display device of the user's device 125.

In particular, the user, USER B, can define the conditions upon which the call is forwarded to the remote location 150, and for processing of the call, once forwarded. The user defined rules are stored in a remote database 145 accessible by the communications processor 140 and a call to USER B is processed in accordance with these rules. In one particular embodiment, the remote location 150 is a centralized call processing center. In another particular embodiment of the invention, the remote location 150 is a centralized call processing center that additionally provides USER B with other services, such as VOIP phone services, via the device 127.

The rules preset by the user and stored in the database 145 of the remote location 150 can define any number of user preferences for the particular user, USER B. For example, the user preferences/rules stored in the database 145 can include, but are not limited to, such information as:

Whether or not to display information of the communication request (i.e., the call) as a pop-up screen on the display of device 125;

Whether or not to forward the communication request to another computer for display as a pop-up screen; and

Whether or not, and under what conditions, to forward the communication request to other devices of USER B.

Similarly, the rules stored in the database 145 could be used to define the way calls are handled in particular situations. For example, the rules stored by the user could enable the server 140 to act as a virtual switchboard, i.e., providing options and/or instructions for the calling party and performing further actions based on the calling parties selections.

For example, using a software module in accordance with the present invention, USER B can preset the rules stored in the database 145 to first present information of the communication request to the display of the device 125, in the form of a pop-up screen, and, upon non-answer of the communication request, to forward the call to other devices of USER B. In one particular embodiment, upon non-answer of the communication request on the device 125, the rules can be set to specify that the call be processed and forwarded to USER B's landline 122, via the PSTN, and to USER B's mobile device 127, simultaneously. This gives USER B the option to select upon which device she takes the call. The rules can additionally define that, upon non-answer on the devices 125, 122 and 127, the call can be provided to a voicemail provider. In one particular embodiment of the invention, the voicemail provider is managed by the same entity as the server 140. Additionally, in such a system, the voicemail message can be associated with the account of USER B in the database 145.

Note that USER B can define other preferences that are stored in the database 145. For example, in one particular embodiment of the invention, USER B can specify, and/or upload to the database 145, a particular song or message to be played to a calling party (USER A, in the present example) while the communication request is being processed and provided to the devices 125, 122, 127.

Once USER B logs out of the P2P network (step 260) and/or exits the particularly described module of the invention, the normal default rules for the P2P network application apply. For example, in the SKYPE network, a registered user is permitted to store a telephone number to which the call will be forwarded if the user is not currently logged-in to the P2P network. In one particular embodiment of the instant invention, if desired, instructions stored in the client and/or user device can be used to inform the P2P/SKYPE network about how to process calls when the user is not currently logged into the P2P network or the user's device is non-responsive to a call request made over the P2P network. Such instructions can include instructions to forward information relating to a call request to the remote location (150 of FIG. 1) for further processing and/or instructions on how to process the call at the remote location, once the information relating to the call request has been forwarded.

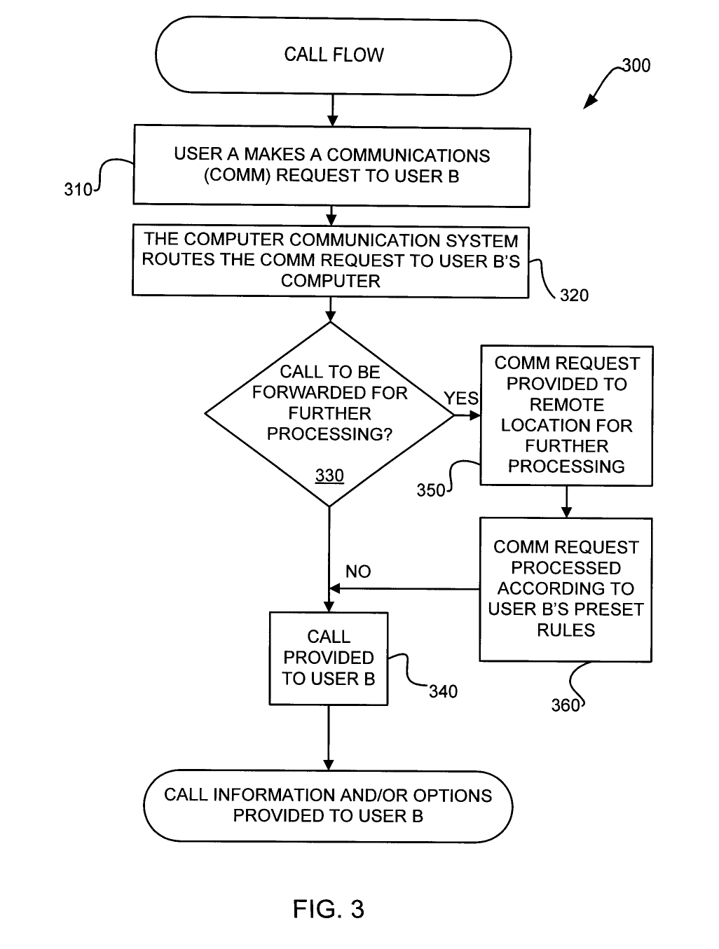

Referring now to FIGS. 1 and 3, a method 300 in accordance with one particular embodiment of the invention will be described with more specificity. In operation, a first registered user (USER A) of a P2P communications network, such as the SKYPE network, running a communications application, such as the SKYPE software application, makes a request to communicate with a second registered user (USER B). Step 310. The communication system routes the communication request made by USER A to the device 125 of USER B. Step 320. More particularly, USER A's device 115 contacts a supernode operating in the P2P communications network to get an IP address for USER B and sends the communication request to the IP address identified with USER B. However, instead of being displayed immediately to USER B, via the display of device 125, a software module in accordance with the present invention intercepts the communication request and determines if it should be sent to the server 140 at the remote location 150 for further processing before being provided to USER B. Step 330. In particular, some types of communication requests can be passed through to the computer of USER B. Step 340. In one particular embodiment of the invention, video carrying calls and/or text chats are provided directly to the display of USER B without being forwarded to the remote location 150 for processing. However, this is not meant to be limiting, because, if desired, video carrying calls and/or text chats can be forwarded for processing in much the same way as is described herein for calls in general.

Next, if the module running in the background of USER B's device 125 determines that the incoming call should be sent for further processing prior to being presented to the user, the communication request received by USER B's device 125 (but not yet displayed to USER B) is forwarded to the server 140 of the remote location 150 for further processing, wherein it is processed in accordance with the rules predefined by USER B, stored in the database 145. Step 360. After such processing, the communication request made by USER A is step 310 can be provided to USER B, in accordance with USER B's preset rules. For example, the communication request can be provided to USER B as a pop-up window on the device 125 that is running the module and/or the communication request can be processed by the server 140 to forward the call to another device of USER B, such as the telephone 122 or mobile device 127 and/or other devices, as defined in the rules previously stored by USER B. Step 340.

In summary, a module in accordance with the present invention sits on a user's computer and waits for a communication request to be received over a P2P network. A received communication request is analyzed and processed in accordance with rules previously defined by the recipient user, before the recipient user is even informed of the receipt of the incoming call. Additionally, the storage of the user's rules, as well as the processing of the communication request in accordance with those rules, is performed on a computer remotely located from both of the recipient user's computer and the calling user's computer. The processing can be used to forward a call from the P2P network, to a device not part of the P2P network, such as to a mobile device, a voicemail address or even a landline telephone reached over the PSTN. Thus, if USER B is not sitting in front of the device 125 at the time the communication request comes in, the opportunity to communicate with the caller is not lost. Rather, the call is passed through to another one of USER B's devices.

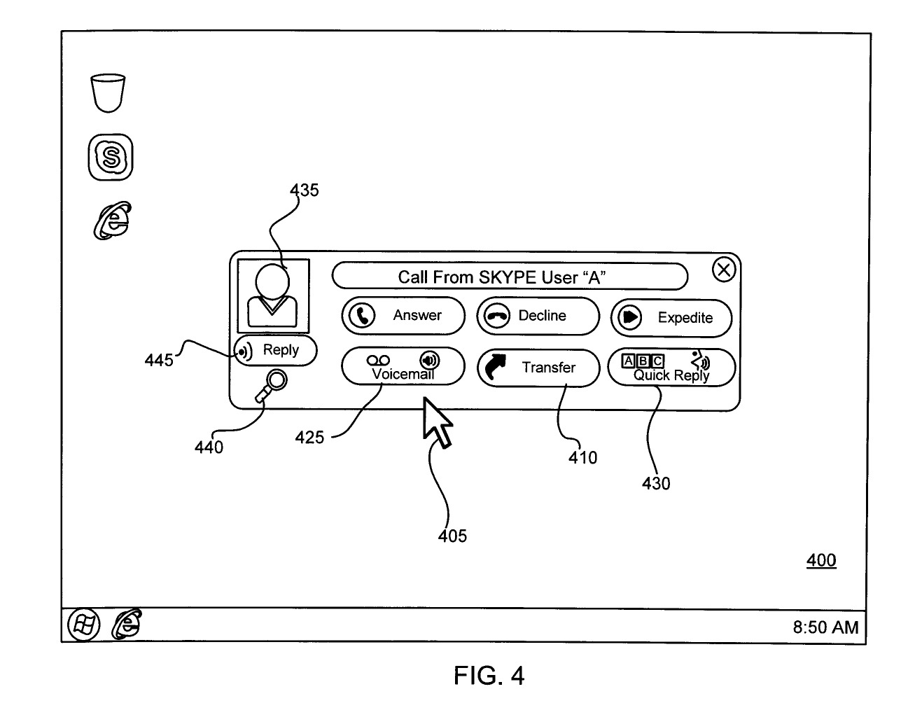

Note that the module of the instant invention can also provide functionality other than the call-forwarding functionality described above. More particularly, referring now to FIG. 4, there is shown one representation of a display device 400 (for example, a display device of device 125 of FIG. 1), displaying a pop-up window 410 generated by execution of the software of one particular embodiment of the instant invention. More particularly, in the embodiment of FIG. 4, the module additionally includes a call-screening feature, whereby, in addition to the traditional “answer” and “decline” options for responding to an incoming communication request, the module generates a further option, such as “voicemail” 425. As such, once the communication request has been processed in accordance with USER B's preset rules, the information of the communication request 420, including the identity of the requesting user, can be provided to USER B with the option to screen the call by sending the call directly to voicemail by mousing over and selecting the voicemail option 425 with a GUI pointer 405. The information 420 identifying the calling party could be stripped and used to visually identify the calling party in association with the user's voicemail. For example, once a call has been provided to USER B's voicemail by pressing the soft button 425 in the window 410, USER B could access the voicemail stored at the server 140 of FIG. 1, via USER B's mobile device 127 of FIG. 1. In such a case, the identifier 420 can be displayed on a screen of the mobile device 127 in connection with the indication of the received voicemail, so that USER B has a visual indication of who left the voicemail. Additionally, because of the use of a centralized location for storing the voicemail (i.e., the server 140 of FIG. 1), the voicemail can be retrieved by USER B using any of the devices 125, 122, 127.

Note that the screening feature described in connection with FIG. 4 could also be implemented, if desired, in a system that does not intercept and forward an incoming communication request in accordance with the instant invention. For example, such an option could also be added to a traditional system, such as the existing SKYPE system. Similarly, additional soft buttons can be provided on the pop-up window 410 for performing other functions under control of the programming of the module of the invention. For example, a “transfer” button could be provided to transfer a call to another recipient, if desired.

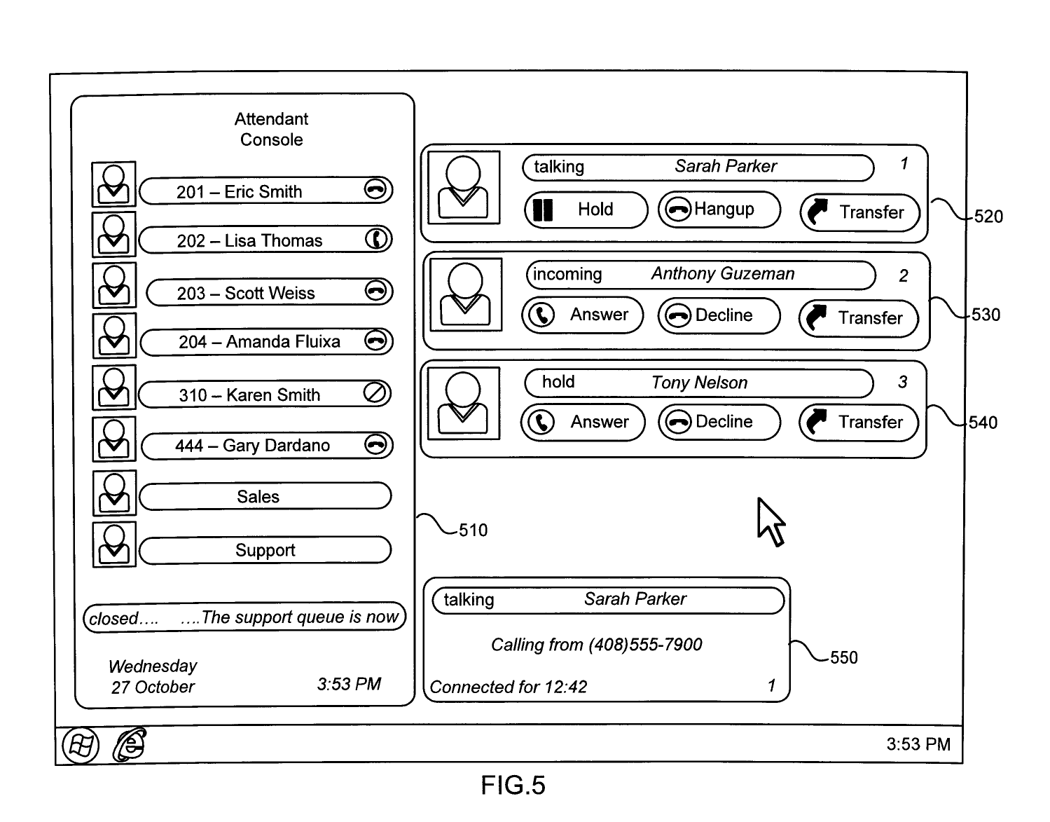

Referring now to FIG. 5, there is shown a representative, exemplary screen shot showing a virtual “attendant console” application running on a user device that is useful in managing the call features provided by the software of one particular embodiment of the instant invention. More particularly, as with the display shown in FIG. 4, the software of the instant invention can be used to generate and display a pop-up window 510 that simulates an “attendant console” used to answer and/or route multiple calls in a queue, as shown. The attendant console system can be used in connection with call screening pop-up windows 520, 530 and 540, which may be implemented as described in connection with window 410 of FIG. 4. An informational dialogue screen 550 may additionally, optionally, be provided. As can be seen, the attendant console 510 can be used to manage multiple incoming calls in the same manner as would be performed by an attendant console in a traditional PBX system. However, the attendant console 510 is used to manage calls received at a user device, via the P2P network.

It should be clear that each block or step of the flowcharts of FIGS. 2-3 and/or combinations of blocks in those flowcharts can be implemented by computer program instructions. The computer program instructions are loadable into a computer or another programmable apparatus to configure a machine (i.e., computer or other device), such that the instructions which are executed on the computer or other programmable apparatus create means for implementing the function specified in the blocks or steps of the flowchart. These computer program instructions may also be stored in a non-transitory computer readable memory, including, but not limited to, a DVD, CD, diskette, hard drive, EEPROM, flash memory or other ROM device, that can direct a computer or other programmable apparatus to function in a particular manner, when executed by a processor of the computer or other programmable apparatus It should also be understood that each block or step of the flowchart and combination of blocks or steps of the flowcharts can be implemented by special purpose hardware based computer systems that perform the specified functional steps or combination using the special purpose hardware configured by the computer instructions.

Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

We claim:

1. A method for processing a communication request addressed to a first device connected as a node of a peer-to-peer network, comprising the steps of:
at the first device, receiving a communication request from the peer-to-peer network, in accordance with software executed on the first device; and
providing information of the received communication request to a computing device at a remote location for further processing before displaying information relating to the received communication request on a display of the first device.

2. The method of claim 1, further comprising the step of:
processing the information of the received communication request at the remote location in accordance with rules stored by a user of the first device before the receiving step.

3. The method of claim 2, wherein the rules are stored in a memory device accessible by the computing device at the remote location.

4. The method of claim 2, wherein the stored rules are used by the computing device at the remote location to determine where a call initiated by the communication request should be routed in addition to the first user device.

5. The method of claim 2, wherein the stored rules are used by the computing device at the remote location to determine where a call initiated by the communication request should be routed instead of to the first user device.

6. The method of claim 2 wherein the stored rules are used by the computing device at the remote location to provide a call initiated by the communication request to at least one other device specified by the user of the first device.

7. The method of claim 6, wherein the at least one other device is one of a landline phone, a VOIP phone, a mobile phone or a voicemail account.

8. The method of claim 6, wherein, if the call is not answered on the at least one other device is not answered, the stored rules are used by the computing device at the remote location to provide the call to at least a further device specified by the user of the first device.

9. The method of claim 2, wherein the stored rules are used by the computing device at the remote location to determine whether or not to display information of the communication request on a display of the first device.

10. The method of claim 1, wherein the remote location is a centralized processing center.

11. The method of claim 1, wherein the software executed on the first device includes a switch selectable by a user of the first device to bypass the providing step in order to display information of the communication request on the display of the first device without further processing at the remote location.

12. A computer program product having program code stored on a non-transitory computer-readable data medium for carrying out the method according to claim 1 when the program product is executed on a computer.

13. A method for processing a communication request addressed to a first device connected as a node of a peer-to-peer network, comprising the steps of:
receiving a communication request at the first device, via the peer-to-peer network;
prior to providing information of the communication request to a display of the first device, determining whether or not information of the communication request should be passed through to the user or if the communication request should be forwarded to a computing device located on the peer-to-peer network remote from the first device;
if it is determined that the communication request should be forwarded in the determining step, performing the further steps of:
forwarding the communication request from the first device to the computing device via the peer-to-peer network without displaying information of the communication request on the display of the first device;
processing the forwarded communication request with the computing device in accordance with rules pre-stored by a user of the first device in a memory device accessible by the computing device; and
after the processing step, providing at least one of the communication request or information of the communication request to at least one device according to the rules pre-stored by the user.

14. The method of claim 13, wherein the at least one device is a device other than the first device that is associated with the user.

15. The method of claim 13, wherein the at least one device is the first device.

16. The method of claim 15, wherein information of the communication request is provided on the display of the first device as a pop-up window.

17. The method of claim 15, wherein the pop-up window includes a call-screening feature button that permits the call initiated by the communication request to be forwarded to a further device or location.

18. The method of claim 17, wherein the further device or location includes a voicemail box wherein voice information can be stored by a caller initiating the communication request as a voicemail.

19. The method of claim 18, wherein information describing the party originating the communication request is stripped from the communication request and stored in association with the stored voicemail.

20. The method of claim 19, wherein the information describing the party is visibly displayed in association with an indicator indicating the stored voicemail on a display of a device associated with the user.

21. The method of claim 16. wherein the pop-up window is part of an attendant console application running on the first device, the attendant console including buttons permitting an attendant to answer and/or route multiple calls originating from multiple nodes of the peer-to-peer network from the pop-up window.

22. A computer program product having program code stored on a non-transitory computer-readable data medium for carrying out the method according to claim 13 when the program product is executed on a computer.

23. A system for processing a communication request on a peer-to-peer network, comprising:
at least a first user device connected to the peer-to-peer network;
at least a second user device connected to the peer-to peer network;
a remote computing device connected to the peer-to-peer network, said remote computing device being disposed at a location remote from at least said first user device;
said first user device being configured to:
a) receive a communication request from said second user device via the peer-to-peer network; and
b) prior to displaying information of the received communication request on a screen of said first user device, forward information of the received communication request to said remote computing device for further processing;
said remote computing device being configured to:
process the forwarded communication request in accordance with rules pre-stored by a user of said first device in a memory device accessible by said remote computing device; and
after processing the forwarded communication, provide at least one of the communication request or information of the communication request to at least one device according to the rules pre-stored by the user.

24. The system of claim 23, wherein said first user device can additionally be configured by a user to pass information relating to communication requests of a certain type or having a certain characteristic to the screen of said first user device without forwarding information of the received communication to said remote computing device.

25. The system of claim 23, wherein the stored rules are used by said remote computing device to determine where a call initiated by the communication request should be routed in addition to said first user device.

26. The system of claim 24, wherein the stored rules are used by said remote computing device to determine where a call initiated by the communication request should be routed instead of to said first user device.

27. The system of claim 24, wherein the stored rules are used by said remote computing device to provide a call initiated by the communication request to at least one other device specified by the user of said first device.

28. The system of claim 24, wherein, wherein said at least one other device is one of a landline phone, a VOIP phone, a mobile phone or a voicemail account.

29. The system of claim 24, wherein, if the call to the at least one other device is not answered, said remote computing device is configured to use the stored rules to provide the call to at least a further device specified by the user of said first device.

30. The system of claim 24, wherein the stored rules are used by said remote computing device to determine whether or not to display information of the communication request on a display of said first device.

31. The system of claim 23, wherein the remote location is a centralized processing center.

32. A method for processing a communication request addressed to a first device using a peer-to-peer network, comprising the steps of:
determining whether or not the first device is currently accessible over the peer-to-peer network in response to a communication request addressed to the first device; and
if, in the determining step, it is determined that the first device is not accessible over the peer-to-peer network, processing the communication request in accordance with instructions stored on the first device.

33. The method of claim 32, wherein the determining step determines whether the first device is logged in to or out of the peer-to-peer network, or is otherwise non-responsive to communications from the peer-to-peer network.

34. The method of claim 32, wherein the processing step includes sending information of the communication request to a remote location.

35. The method of claim 34, wherein the information of the communication request is processed at the remote location in accordance with instructions previously stored at the remote location.

36. The method of claim 34, wherein the information of the communication request is processed at the remote location in accordance with instruction s stored in the first device.
